(19) United States
(12) Patent Application Publication
(10) Pub. No.: US 2026/0331082 A1
(43) Pub. Date: Oct. 22, 2026

(54) METHOD OF ENCODING MUSIC INFORMATION, CORRESPONDING COMPUTER PROGRAM PRODUCT AND MUSIC INFORMATION DISPLAY APPARATUS

(71) Applicants: Matteo SALVADORI, Torino (IT); BUSSOLINO-SITCAP S.A.S DI G. BUSSOLINO & C., Torino (IT)

(72) Inventor: Matteo SALVADORI, Torino (IT)

(21) Appl. No.: 19/116,731

(22) PCT Filed: Sep. 25, 2023
(86) PCT No.: PCT/IB2023/059441

§ 371 Date: Mar. 28, 2025

(30) Foreign Application Priority Data
Sep. 29, 2022 (IT) 102022000020043

(51) Int. Cl. G10H 1/00; G10G 1/00

(52) U.S. Cl. CPC G10H 1/0008; G10G 1/00; G10H 2220/011

(57) ABSTRACT

In a method of encoding music information, a database that stores music information of a song in the form of a sequence of notes and a text is accessed. The text is dividable in a sequence of graphemes, each corresponding to a note of the sequence of notes. A reference note is selected from the sequence of notes. Each note of the sequence of notes is associated to a scale degree selected out of twelve scale degrees within an octave, relative to a reference degree that corresponds to the reference note. Twelve mutually different colors are associated to the twelve scale degrees. The mutually different colors are selected as a function of a scale degree-to-color function that links each scale degree to a respective color. The notes of the sequence are divided in different groups corresponding to different musical octaves. One or more specific typographic attributes are associated to each musical octave. For each of the graphemes, data indicative of the color associated to the scale degree of the note that corresponds to the grapheme and data indicative of the one or more specific typographic attributes associated to the musical octave to which the note that corresponds to the grapheme belongs is stored.

### TECHNICAL FIELD

The description relates to methods and apparatuses for encoding and optionally displaying music information according to a new musical notation, where the encoded music information includes the text (e.g., lyrics) of a song, and the degree and the octave of the corresponding notes for singing.

### TECHNOLOGICAL BACKGROUND

A musical notation can be defined as the visual record of musical sound, or a set of visual instructions for performance of music. Another definition of musical notation is any system used to visually represent aurally perceived music played with instruments or sung by the human voice through the use of written, printed, or otherwise-produced symbols, possibly including notation for durations of absence of sound such as rests.

As of today, the most common way of displaying music information of a song (e.g., the lyrics and melody of the song) is that of displaying the melody in the form of a sequence of notes (and rests) on a staff, with the text of the lyrics displayed below the staff in positions corresponding to the respective notes. This way of displaying music information is also referred to as “classic western notation” or “staff notation”.

However, such a conventional musical notation has some disadvantages: it requires the singer to be able to read a melody on a staff; it requires the singer to read simultaneously information from two lines at different heights (i.e., the melody line on the staff and the lyrics line below it), which implies many saccades (i.e., binocular eye movements) during which the singer cannot gain visual information; it requires the singer to read symbols with different reading difficulty levels; and it requires the singer to be able to read different key signatures or to read changes of key signature on a staff. All these requirements may be complex especially for beginners and/or during sight-singing. Additionally, the conventional musical notation may be cumbersome for editors and designers that have to lay out the staff and the text of the musical score on a page or display them fixed, scrolling, or animated on a screen, possibly with transpositions.

Musical notation systems other than the staff notation are known, e.g., from documents US 9406241 B2, US 6831219 B1, US 10013961 B1, US 6639139 B2, CN 106205569 A, US 8697974 B1, US 9196171 B2, and US 10083622 B1.

Another musical notation is known from document KR 2005/0108831 A, which discloses a method for displaying music information of a song during karaoke. Different durations (each of the sounds sound corresponding to a grapheme) are indicated either by displaying different images above the graphemes, or by displaying the same image with different sizes above the graphemes, or by varying the size of the graphemes. Further, the pitch of the notes is indicated by displaying the graphemes at different heights (i.e., different vertical positions) along the line of text. Only an approximated indication of the pitch is given (e. g., each octave is divided in just two pitches). Therefore, the musical “score” produced by this method is approximated and still requires the user to read simultaneously different symbols at different heights, implying many saccades.

Another musical notation is known from document US 2002/0050206 A1. In this notation, the duration of each sound is indicated by a number of rectangles depicted below each grapheme. The absolute pitch of the notes is indicated by using seven colors associated to seven notes, plus using the conventional accidentals symbols (sharp and flat) for the remaining notes. Different octaves are indicated using vertical dashes placed before or after the graphemes. Therefore, the musical score produced by this method is rich of additional symbols (rectangles, accidentals, dashes) and implies many saccades during reading.

Another musical notation is known from document KR 100381682 B1, which discloses a method for displaying music information of a song on a screen during karaoke. The graphemes appear on the screen in time to the music. The absolute pitch of the notes is indicated by displaying the graphemes at different heights (i.e., different vertical positions) along the line of text, as well as using twelve colors associated to twelve notes. Different octaves are rendered with different brightness levels of the same color. Therefore, this musical notation can be adopted only on electronic screens (in order to reproduce different brightness levels for different octaves), and it implies many saccades during reading, insofar as the graphemes are arranged at different heights along the line of text.

Therefore, there is a need in the art to provide a musical notation that efficiently guides the performance/execution of a singer who sings while reading from a score (e.g., sight-singing), reducing saccades to allow for better visual perception and information processing, and subsequent better skeletal-muscular response (e.g., better voice sound and/or intonation).

Additionally, there is a need in the art to provide a musical notation that facilitates the production of musical scores by editors.

### Object and Summary

An object of one or more embodiments is to contribute in providing such musical notation, and related methods and apparatuses for encoding musical information.

According to one or more embodiments, such an object can be achieved by a method of encoding music information having the features set forth in the claims that follow.

One or embodiments may more relate to a corresponding computer program product loadable in the memory of at least one processing circuit (e.g., a computer) and including software code portions for executing the steps of the method when the product is run on at least one processing circuit. As used herein, reference to such a computer program product is understood as being equivalent to reference to a computer-readable medium containing instruction for controlling the processing system in order to co-ordinate implementation of the method according to one or more embodiments. Reference to “at least one processing circuit” is intended to highlight the possibility for one or more embodiments to be implemented in modular and/or distributed form.

One or more embodiments may relate to a corresponding apparatus for displaying music information.

The claims are an integral part of the technical teaching provided herein in respect of the embodiments.

According to a first aspect, a method of encoding music information comprises accessing a database that stores music information including, but not limited to, analog or digital audio files, symbolic music representation data files such as XML and MIDI files, digital or printed score/sheet music representations) of a song in the form of a sequence of notes (e.g., a note may be construed as a single tone of definite pitch made by a musical instrument or audio signal processing application or the human voice, or a written symbol or a code that represents such a sound) and a text (e. g., the lyrics of the song). The text is dividable in a sequence of graphemes (e.g., according to the writing system used, such as an alphabetical system, an abjad system, an abugida system, a logographic system or a syllabic system and the like, a grapheme may be construed as a graphic representation of a sound, a phoneme, a mora, a syllable, a morpheme, or generally of a phonetic unit or segment). Each grapheme of the sequence of graphemes corresponds to a note of the sequence of notes. A reference note (e.g., focal, central, base, root, tonic, fundamental note or even an arbitrarily selected note) is selected from the sequence of notes. Each note of the sequence of notes is associated to a scale degree selected out of twelve scale degrees within an octave relative to a reference degree that corresponds to the reference note. Twelve mutually different colors are associated to the twelve scale degrees. The mutually different colors are selected as a function of a bijective scale degree-to-color function that links each scale degree to a respective color. The notes of the sequence of notes are divided in different groups corresponding to different musical octaves. Each note of the sequence of notes belongs to a musical octave. One or more specific typographic attributes are associated to each of the different musical octaves. For each of the graphemes, data indicative of the color associated to the scale degree of the note that corresponds to the grapheme and data indicative of the one or more specific typographic attributes associated to the musical octave to which the note that corresponds to the grapheme belongs is stored.

One or more embodiments may thus facilitate encoding music information in a format that is easily producible by the editor and easily readable by the singer.

According to another aspect, a computer program product loadable in the memory of at least one processing device comprises software code portions configured to cause the at least one processing device to operate according to the method of one or more embodiments as a result of the product being run on the at least one processing device.

According to another aspect, a music information display apparatus comprises a display device and a processing device configured to operate according to the method of one or more embodiments to produce drive signals for the display device to render on a display support a sequence of graphemes colored with the color associated to the scale degree of the note that corresponds to the grapheme, as well as formatted and/or typeset with the one or more specific typographic attributes associated to the octave to which the note that corresponds to the grapheme belongs.

### BRIEF DESCRIPTION OF THE DRAWINGS

One or more embodiments will now be described, by way of example only, with reference to the annexed figures, wherein:

FIGS. 1 to 4 are examples of possible text encodings of notes respectively in key of C major, D major, A natural minor, and B natural minor according to embodiments of the musical notation;

FIG. 5A is an excerpt from a song displayed according to a conventional staff notation, FIG. 5B shows in colors the same excerpt encoded according to one embodiment of the musical notation, and FIG. 5C is a greyscale reproduction of FIG. 5B;

FIG. 6A is an excerpt from another song displayed according to a conventional staff notation, FIG. 6B shows in colors the same excerpt encoded according to one embodiment of the musical notation, FIG. 6C is a greyscale reproduction of FIG. 6B, FIG. 6D is a reproduction of FIG. 6B including captions, and FIG. 6E is a greyscale reproduction of FIG. 6D;

FIG. 7A is an excerpt from another song displayed according to a conventional staff notation, FIG. 7B shows in colors the same excerpt encoded according to one embodiment of the musical notation, including an indication of a change of reference note (e.g., a modulation), FIG. 7C is a greyscale reproduction of FIG. 7B, FIG. 7D shows in colors the same excerpt encoded according to another embodiment of the musical notation, which does not include indication of the change of reference note, and FIG. 7E is a greyscale reproduction of FIG. 7D;

FIG. 8A shows in colors the full text of the song of FIGS. 6A to 6E encoded according to one embodiment of the musical notation, and FIG. 8B is a greyscale reproduction of FIG. 8A;

FIG. 9A shows in colors the full text of the song of FIGS. 7A to 7E encoded according to one embodiment of the musical notation, including indication of changes of the reference note (e. g., music modulations), and FIG. 9B is a greyscale reproduction of FIG. 9A;

FIG. 10A shows in colors the full text of the song of FIGS. 8A and 8B encoded according to one embodiment of the musical notation, including typographic symbols and/or marks that indicate the structure, meter and/or rhythm of the song, and FIG. 10B is a greyscale reproduction of FIG. 10A;

FIG. 11A shows in colors the full text of the song of FIGS. 9A and 9B encoded according to one embodiment of the musical notation, including typographic symbols and/or marks that indicate the structure, meter and/or rhythm of the song, and FIG. 11B is a greyscale reproduction of FIG. 11A; and

FIGS. 12 to 14 are flow diagrams exemplary of a method of encoding musical information according to one or more embodiments.

### DETAILED DESCRIPTION OF EXEMPLARY EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

A way of acquiring musical information for the general public (e.g., leaving aside professional singers who are acquainted with reading the standard staff notation) is that of listening to songs from audio sources (e.g., radio sources or other audio streaming sources). The text of a song thus plays a key role in the learning process. Based on this recognition, a new musical notation is proposed herein, which relies on displaying the text of a song formatted according to a set of rules (e.g., an encoding) so that information about the melody of the song can be inferred by the singer directly from the way the text is displayed (e.g., printed on a sheet of paper or displayed on a display screen, such as an electronic screen, smart glasses, a virtual/augmented reality headset, a foldable display, and the like). Additional musical information (e.g., concerning the structure, meter and/or rhythm of the song) can be encoded within the text, e.g., by resorting to the use of punctuation symbols or other typographic symbols or marks (e.g., combining characters including diacritical marks), so that the entirety of the musical information of a song can be encoded in a text by using conventional text formatting tools (e.g., using a word processing software running on a personal computer, PC).

Therefore, such a novel musical notation is advantageous for the end user insofar as it allows the singer to simultaneously read the melody and the lyrics of a song on the same line of text, reducing the saccades and thus allowing more time to gain information. In particular, the novel musical notation allows the reader (singer) to keep the foveal area of his/her field of vision on only one graphic symbol for getting information about both the scale degree and the phonetic unit or segment to be sung, and on a single reading line (e.g., horizontal line) for the entire sequence of graphemes of a song, thus reducing the number of ocular saccades (during which the user cannot gain visual information) and allowing more time for ocular fixations (which allow the user's visual system to acquire detailed information about what is being viewed). Thereby, music reading is improved by producing in the user's mind an effect that depends on physical parameters based on human physiology, i.e., less saccades and more time for fixations, which in turn allows for better visual perception and information processing, turning into better skeletal-muscular response, particularly during sight-singing.

Additionally, the novel musical notation proposed herein is advantageous for the creator (e.g., editor) of the musical score, since a sheet music according to the new notation can be generated manually or with automated processes starting from different kind of music sources (e.g., audio or symbolic sources) via conventional text formatting tools. Moreover, the novel musical notation is advantageous for designing innovative animated musical scores to be implemented via video editing or kinetic typography tools, manually or with automated processes, in several industries (e.g., music video, mobile app, augmented or virtual reality, tv and motion picture). Also, the novel musical notation proposed herein is advantageous insofar as it facilitates producing a sheet music for songs in writing systems that are different from the alphabetic (left-to-right) system, such as, for instance, an abjad right-to-left writing system (e. g., Hebrew and Arabic), or a logographic top-to-bottom writing system.

The musical notation disclosed herein relies on representing, for any musical system that encompasses 12 degrees or pitches per octave (such as, for instance, Western Music, Indian Classical Music (e.g., 12 svaras), Bollywood Music, Chinese Music (e.g., 12 lü)), regardless of the tuning system or musical temperament, the degree of each note of the melody (within an octave) and the octave of each note of the melody by formatting and/or typesetting (e.g., coloring or highlighting in color, changing the style or font, repeating characters representing vowels) the lyrics of the song according to a set of rules (e.g., encoded). Additionally, and not mandatorily, the proposed musical notation can represent changes of tonality/key/mode (e.g., modulations) in the melody. Additionally, and not mandatorily, the proposed musical notation can represent note values (i.e., the relative duration of the notes), rests and meters or generally other rhythmic information.

Therefore, in one or more embodiments of the proposed musical notation the degree of each note of the melody is represented by the color (including not only the coloring of the characters, but also other possibilities such as the highlighting of the text) and the octave of each note of the melody is represented by the typographical attributes used to format and/or typeset the corresponding text/lyrics (e.g., each grapheme corresponding to a syllable or vowel) of the song itself. In other words, the color of the font or the color with which the font is highlighted represents the degree within an octave, and the typographical attributes of the font represent different octaves.

In one or more embodiments, the proposed musical notation thus relies on the univocal association of a sequence of twelve colors to the twelve degrees of the chromatic scale or any twelve-tone scale. This system is also referred to as a colored relative scale (CRS). Table I that appears at the end of the description is an example of a possible color encoding that associates twelve scale degrees to twelve colors via a bijective function according to one embodiment, where:
a first degree (“degree no. 1”) is associated to the grey color; it plays the role of a “reference” degree; by way of example, this could be associated to the tonic of the scale in a diatonic system;
a second degree (“degree no. 2”) is associated to the indigo color; it lies at one half-tone ascending from the reference degree; by way of example, this could be associated to the lowered supertonic of the scale in a diatonic system;
a third degree (“degree no. 3”) is associated to the cherry color; it lies at two half-tones ascending from the reference degree; by way of example, this could be associated to the supertonic of the scale in a diatonic system;
a fourth degree (“degree no. 4”) is associated to the azure color; it lies at three half-tones ascending from the reference degree; by way of example, this could be associated to the raised supertonic or lowered mediant of the scale in a diatonic system;
a fifth degree (“degree no. 5”) is associated to the green color; it lies at four half-tones ascending from the reference degree; by way of example, this could be associated to the mediant of the scale in a diatonic system;
a sixth degree (“degree no. 6”) is associated to the yellow color; it lies at five half-tones ascending from the reference degree; by way of example, this could be associated to the subdominant of the scale in a diatonic system;
a seventh degree (“degree no. 7”) is associated to the olive color; it lies at six half-tones ascending from the reference degree; by way of example, this could be associated to the raised subdominant or lowered dominant of the scale in a diatonic system;
an eighth degree (“degree no. 8”) is associated to the red color; it lies at seven half-tones ascending from the reference degree; by way of example, this could be associated to the dominant of the scale in a diatonic system;
a ninth degree (“degree no. 9”) is associated to the purple color; it lies at eight half-tones ascending from the reference degree; by way of example, this could be associated to the dominant or lowered submediant of the scale in a diatonic system;
a tenth degree (“degree no. 10”) is associated to the black color; it lies at nine half-tones ascending from the reference degree; by way of example, this could be associated to the submediant of the scale in a diatonic system;
an eleventh degree (“degree no. 11”) is associated to the orange color; it lies at ten half-tones ascending from the reference degree; by way of example, this could be associated to the subtonic of the scale in a diatonic system; and
a twelfth degree (“degree no. 12”) is associated to the pink color; it lies at eleven half-tones ascending from the reference degree; by way of example, this could be associated to the leading tone of the scale in a diatonic system.

The same set of colors used to identify the twelve degrees of one octave (e.g., from the tonic to the leading tone) repeats identically for the other octaves (lower and upper).

Table II that appears at the end of the description shows examples of some diatonic scales represented with the colored relative scale according to one or more embodiments, where degree no. 1 (associated to the grey color) corresponds to the tonic of the scale (which may play the role of a “reference” note), e.g.:
a scale of A natural minor, where A=grey, B=cherry, C=azure, D=yellow, E=red, F=purple, G=orange, and again A=grey;
a scale of C major, where C=grey, D=cherry, E=green, F=yellow, G=red, A=black, B=pink, and again C=grey; and
a scale of C harmonic minor, where C=grey, D=cherry, Eb=azure, F=yellow, G=red, Ab=purple, B=pink, and again C=grey.

It is noted that, as used herein, the wording “reference note” indicates a note (e.g., A) that is selected to correspond to the “reference degree” of the colored relative scale, independently from its absolute pitch. For instance, note A at 440 Hz and its upper octave at 880 Hz would be interpreted as the same “reference note” because a certain song would be encoded in the same way (i.e., according to the same bijective scale degree-to-color function) independently from which note A (e.g., at 440 Hz, 880 Hz or 220 Hz) is selected to be the reference note. In other words, the wording “reference note” may indicate a pitch class or chroma.

In one or more embodiments, the choice of the twelve colors to be assigned to the twelve degrees can be made in view of establishing a musical relation between the selected color and scale degree, and in view of improving the effectiveness of the visual rendering and the ease of reading, given the different importance of each degree in the tonal system. For instance, the dominant degree (e.g., an ascending perfect fifth interval from the tonic) usually plays an important role in the melody of a song, so that it can be assigned the red color that easily stands out in the displayed text. Other relevant degrees usually include the mediant degree (e.g., an ascending major third interval from the tonic) that can thus be assigned the green color, and the subdominant degree (e.g., an ascending perfect fourth interval from the tonic) that can thus be assigned the yellow color. However, it will be understood that the specific color encoding discussed herein is just an example of a possible encoding, and that any other color encoding (i.e., any other choice of twelve different colors to be associated to twelve degrees of the scale) may be used in variant embodiments. For instance, the twelve colors listed in Tables I and II can be arranged in a different order, or other colors can be envisaged.

In one or more embodiments, the proposed musical notation relies, in addition to the use of different colors for displaying the text associated to different degrees within an octave, on the use of different typefaces or other typographical attributes of the font employed to display the text of the song (e.g., the graphemes) to represent different octaves (e. g., relative to a “base” or “reference” octave) of the notes of the melody of the song. In other words, graphemes corresponding to notes that pertain to different octaves may be displayed with a text that has a different graphic appearance. An octave can be defined as the interval between the first note and the thirteenth note of the chromatic scale, or as the interval between one musical pitch and another pitch with double frequency, or as a series of thirteen notes (pitches) occupying the interval between (and including) two notes (pitches), one having twice or half the frequency of vibration of the other.

For instance, in one or more embodiments different octaves may be distinguished by using different weights of a same typographic font. By way of example, a higher (respectively, lower) octave may be associated to a lighter (respectively, heavier) font weight: a thin (or hairline, ultra-light, extra-light, light) weight may be associated to a high octave, a book (or normal, regular, plain) weight may be associated to a lower octave, a medium (or semi-bold, demi-bold, bold) weight may be associated to a further lower octave, and an extra-bold (or extra, heavy, black) weight may be associated to a still further lower octave. Of course, the opposite choice can alternatively be made, where a higher octave may be associated to a heavier font weight. Additionally or alternatively, different octaves may be distinguished by using other attributes of the font such as the size, the style, the angle, the slope, the width, and the like. Additionally or alternatively, different octaves may be distinguished by using different fonts of the same typeface, or by using different typefaces within the same text. By way of example, a BRADLEY HAND ITC© typeface may be associated to a high octave, a COURIER NEW© typeface may be associated to a lower octave, an ARIAL NARROW© typeface may be associated to a further lower octave, and a BERLIN SANS FB BOLDO typeface may be associated to a still further lower octave.

It is noted that the notes pertaining to a “same octave” as intended herein, and thus displayed with the same graphic appearance of the typeface, do not need to be in the range from degree no. 1 to degree no. 12 (e. g., from a tonic to a leading tone). Any sequence of twelve consecutive degrees may define an octave: for instance, in one or more embodiments, the style (or graphic appearance) of the font may change starting from degree no. 10 included (i.e., nine half-steps or half-tones above degree no. 1, which may be the tonic), showing the beginning of a higher octave, until the subsequent degree no. 9 included. A lower octave may thus begin (in a descending way) from degree no. 9 included (i.e., four half-tones below degree no. 1, which may be the tonic). For instance, referring to diatonic scales: in key of C major, the first note of the octave may correspond to the note A lower than the tonic (C), thus associated to the black color; in key of A minor, the first note of the octave may represent the note F #lower than the tonic (A), thus also associated to the black color. Table III that appears at the end of the description shows an example of a possible color encoding for the twelve degrees, combined with a possible typeface encoding for different octaves (i.e., a possible bijective function that assigns different typographical attributes to different octaves), where each octave includes the degrees numbered from no. 10 to subsequent no. 9. Alternatively, the change of octave may be intended to happen at any other degree of the scale (e.g., at degree no. 1).

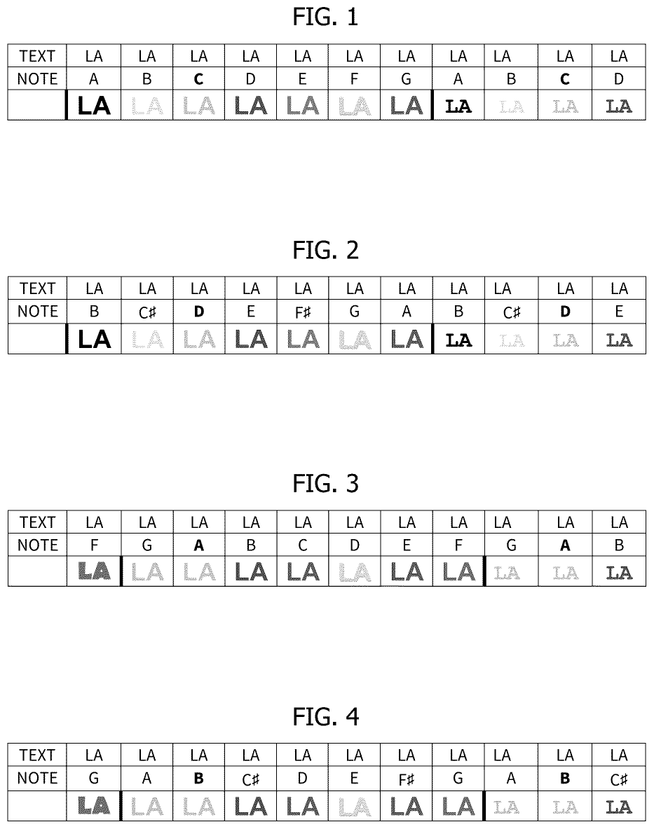

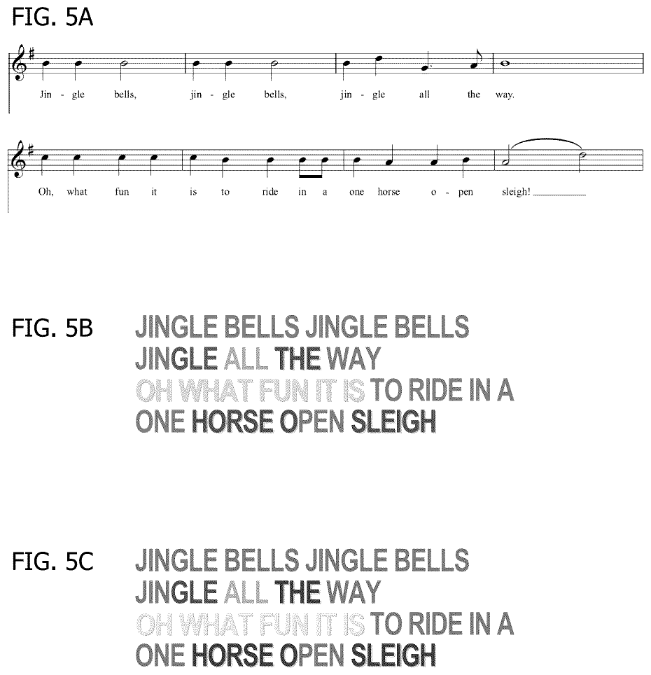

Therefore, in one or more embodiments of the proposed musical notation, different colors and different typographical attributes of the font used to notate each grapheme (e.g., each syllable and/or vowel, even a vowel of a melisma) of the text of a song define the ascending interval, measured in half-steps, of the corresponding note relative to a reference note, and thus the pitch with which that syllable (or vowel) has to be sung. As a way of example, encoding a Western musical tradition's song (e.g., tonal music) according to the proposed musical notation, the output could also be identical independently from the information about the key signature stored in the database (e.g., a lead sheet with the melody written in the key of C, a digital score in the key of A flat, an audio source with the tune sung in the key of E, or one sung in the key of D flat). For instance, FIG. 1 is an example of an encoding of a text (with grapheme “LA” used just for exemplary purposes) in key of C major according to one embodiment. FIG. 2 is an example of an encoding of a text in key of D major according to one embodiment. FIG. 3 is an example of an encoding of a text in key of A natural minor according to one embodiment. FIG. 4 is an example of an encoding of a text in key of B natural minor according to one embodiment. In FIGS. 1 to 4, the grey color (degree no. 1, which plays the role of a reference degree) is always associated to the tonic of the scale (which plays the role of a reference note), but again it will be understood that this is not mandatory.

By way of further example, FIG. 5A shows an excerpt from the song “Jingle Bells” (words and music by J. Pierpont) in key of G major according to a conventional staff notation, while FIG. 5B shows in colors the same excerpt in the same key according to one embodiment of the musical notation proposed herein, and FIG. 5C reproduces FIG. 5B in greyscale. Degree no. 1, corresponding to grey color, is selected to correspond to the tonic note, that is G (albeit such a correspondence of degree no. 1 with the tonic note is not mandatory, as previously discussed, insofar as one or more embodiments are suitable to be applied to atonal music as well). Moras and syllables corresponding to degree no. 5 (e.g., the mediant, note B, that lies at an ascending major third interval from the tonic) are displayed in green, those corresponding to degree no. 8 (e.g., the dominant, note D, that lies at an ascending perfect fifth interval from the tonic) are displayed in red, those corresponding to degree no. 1 (e.g., the tonic, note G, that lies at a perfect prime interval from the tonic) are displayed grey, those corresponding to degree no. 3 (e.g., the supertonic, note A, that lies at an ascending major second interval from the tonic) are displayed in cherry, and those corresponding to degree no. 6 (e.g., the subdominant, note C, that lies at an ascending perfect fourth interval from the tonic) are displayed in yellow, according to the encoding previously discussed with reference to Table I.

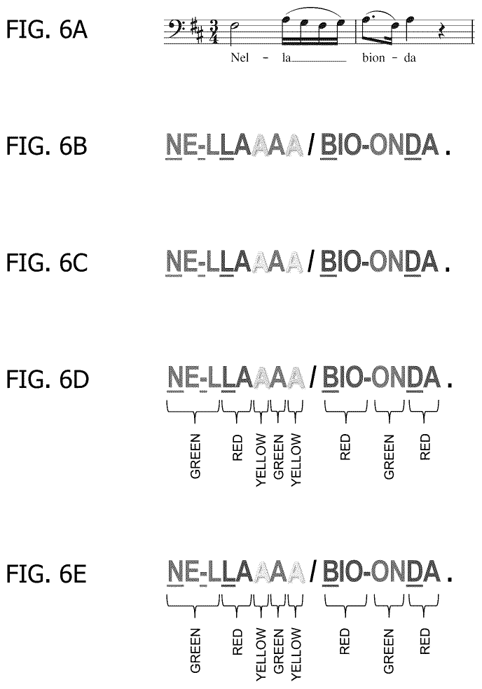

By way of additional example, FIG. 6A shows an excerpt from the aria “Madamina, il catalogo è questo” from Don Giovanni, act I, scene 5 (music by Wolfgang Amadeus Mozart, words by Lorenzo da Ponte) in key of G major according to a conventional staff notation, while FIG. 6B shows the same excerpt in the same key according to one embodiment of the musical notation proposed herein, FIG. 6C reproduces FIG. 6B in greyscale, FIG. 6D reproduces FIG. 6B with captions indicating the colors used, and FIG. 6E reproduces FIG. 6D in greyscale. In the example of FIGS. 6A to 6E, it is also shown that in case of a melisma, the single grapheme of the prolonged vowel “A” in the middle of the text is repeated as many times as there are different notes, because that single letter corresponds to plural vowels/phonemes. It is noted that in the Figures annexed herein, different colors may be rendered with different shades of grey.

Additionally, one or more embodiments of the proposed musical notation may rely on the use of graphical elements (e.g., symbols) associated to the displayed text to indicate changes of the reference note (e.g., a change of tonic, key, scale, or mode) while maintaining the relative color encoding previously described.

For instance, a portion of the text highlighted or surrounded with one of the colors of the colored relative scale may identify a change of reference note (e.g., a modulation to a new key). The portion of text following a change of reference note can be highlighted, for instance, with a colored frame surrounding the graphemes concerned, and/or with colored underlining, overlining, highlighting, background, brackets or any other distinctive colored mark/symbol. The color used to highlight the text represents the degree between the reference note (e.g., tonic) of the following portion of the melody and the reference note (e.g., tonic) of the preceding portion of the melody according to the encoding used for the preceding portion of the melody. Once the portion of the song that uses a different reference note ends (e.g., once a modulation ends and the song reverts to the original tonality), highlighting can be terminated to indicate that the notation is again to be read according to the previous encoding.

In the case of multiple changes of reference note (e.g., if consecutive modulations occur in the song), a new highlighting may be used to indicate the new reference note. Two options are possible for selecting the color that highlights the succeeding portion of the song:
the color used to highlight the text in the new key represents the degree between the reference note (e.g., tonic) of the new key and the reference note (e.g., tonic) of the original/starting key; or
the color used to highlight the text in the new key represents the degree between the reference note (e. g., tonic) of the new key and the reference note (e.g., tonic) of the preceding/last key.

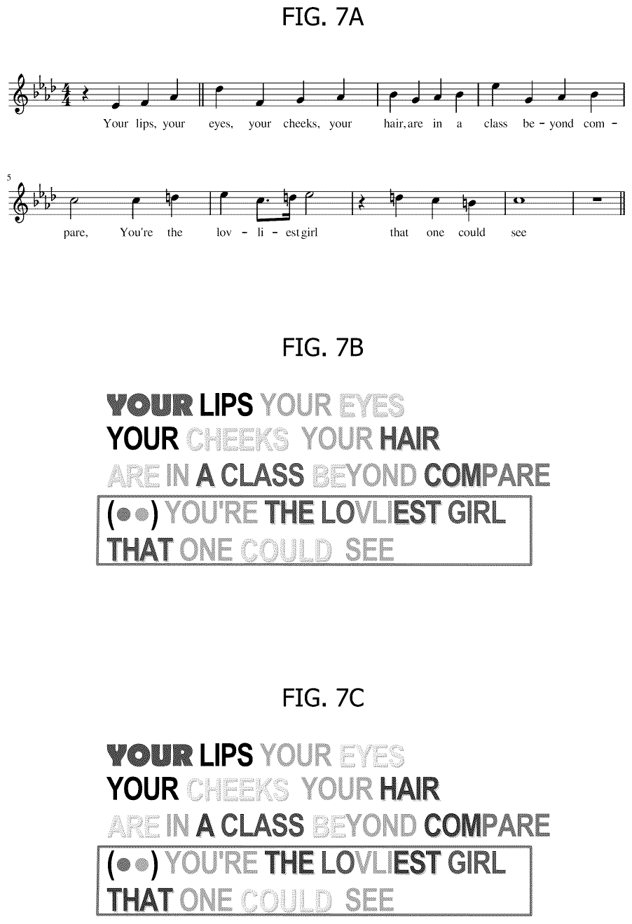

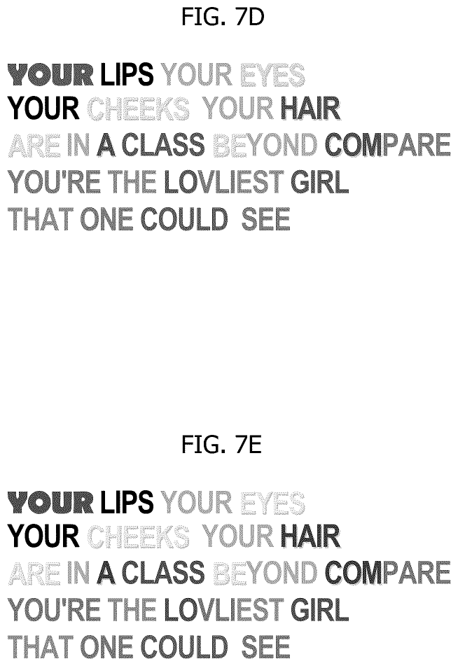

Additionally or alternatively, one or more embodiments of the proposed musical notation may encode the changes of the reference note (e. g., music modulations) by relying on the use of transition symbols displayed within the text where a change of reference note occurs, in particular right before the first grapheme that follows the change. Such a symbol may include two colored portions, the first of which is colored with the color of the degree of the phoneme where the change (e.g., modulation) occurs as it would be according to the encoding of the previous key, and the second of which is colored with the color of the degree of that phoneme as it is according to the encoding of the new key. By way of example, such a symbol may include two colored circles between brackets, as exemplified in FIG. 7B.

In particular, FIG. 7A shows an excerpt from the song “They Didn't Believe Me” (music by Jerome Kern, lyrics by Herbert Reynolds) according to a conventional staff notation, while FIG. 7B shows in colors the same excerpt according to one embodiment of the musical notation proposed herein, and FIG. 7C reproduces FIG. 7B in greyscale. The excerpt in this example starts in A-flat major and modulates to C minor before the word “you're”. Therefore, according to the notation of FIG. 7B, the following portion of the text is surrounded by a green box because degree no. 1 of the new key (the tonic C) corresponds to degree no. 5 of the former key (the mediant C). Additionally, a transition symbol includes a first dot colored in green and a second dot colored in grey, since the color of the degree of the syllable “you're” (note C) in the previous key (A-flat major) would be green (indicating degree no. 5), and the color of the degree of that syllable “you're” (note C) in the new key (C major) is grey (indicating degree no. 1). It is noted that, since the second dot is colored by definition with the same color of the subsequent grapheme, the second dot may be omitted in the transition symbol. FIG. 7D shows in colors the same excerpt of FIG. 7B according to another embodiment of the musical notation, where the same melody is encoded without changing the reference note where the modulation occurs. FIG. 7E reproduces FIG. 7D in greyscale. Here, it is noted that the predominant color in the last two lines of text is green, corresponding to what would be the color grey if this whole portion of text had been framed in green (as shown in FIG. 7B), because, given our initial database input source (refer to FIG. 7A) in which the initial key is A flat, note C corresponds to degree no. 5 if note A flat is degree no. 1. The result of not framing such portion is consequently the more frequent appearance of colors not present in the most familiar western musical scales (major, natural and harmonic minor), such as color olive (corresponding to degree no. 7).

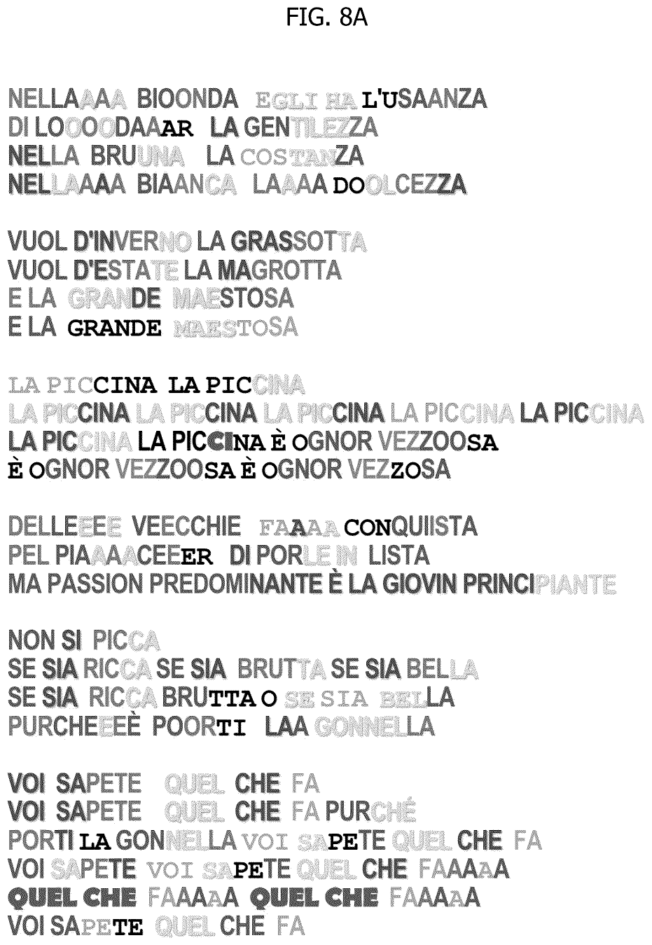

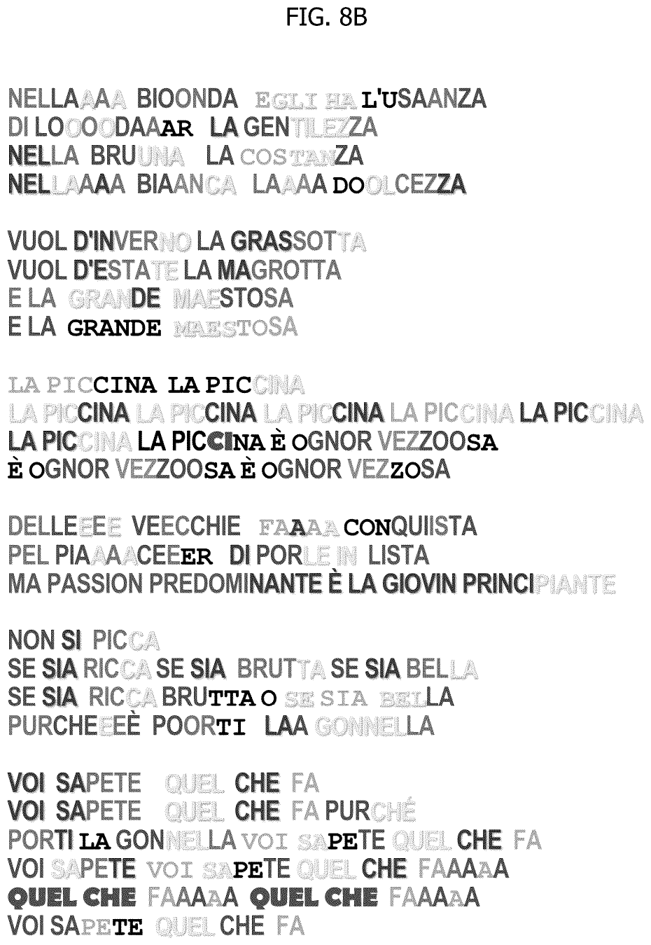

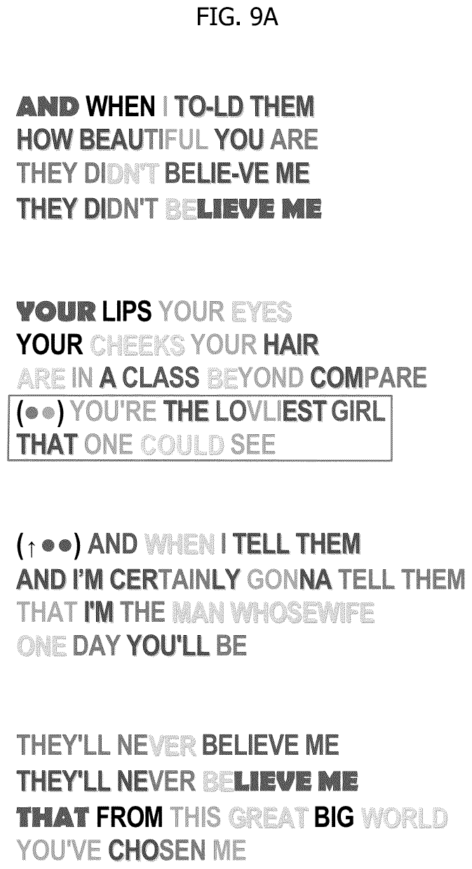

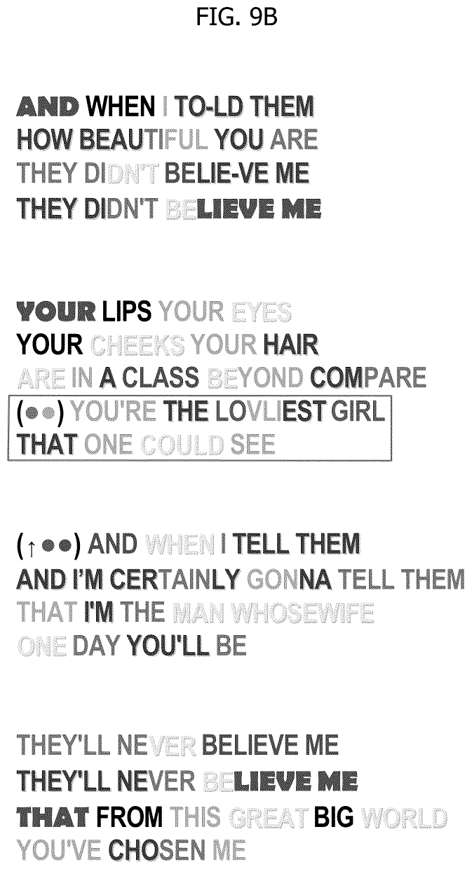

By way of further examples, FIG. 8A shows in colors the full text of the aria of FIGS. 6A to 6E, in key of B major according to one embodiment of the musical notation proposed herein. FIG. 8B reproduces FIG. 8A in greyscale. Here, different colors are used to indicate different degrees of the scale according to the encoding exemplified in Table I, and different typefaces are used to indicate notes in different octaves according to the encoding exemplified in Table III (see for instance the first line: “NELLAAAA BIOONDA” formatted in Arial Narrow typeface, “EGLI HA L′U” formatted in Courier New typeface to indicate a higher octave, and “SAANZA” formatted again in Arial Narrow typeface to indicate the lower octave). Similarly, FIG. 9A shows in colors the full text of the song of FIGS. 7A to 7C, according to one embodiment of the musical notation proposed herein. FIG. 9B reproduces FIG. 9A in greyscale. Here, in addition to different colors and different typefaces, colored graphic symbols are also used to indicate changes of the reference note. Here, it is noted that a transition symbol may additionally include an arrow pointing upward or downward (or another suitable graphic indication) preceding the (two) colored portions of the symbol, which indicates if the movement to the corresponding new color is upward or downward, as exemplified in FIGS. 9A and 9B before the phrase “ . . . and when I tell them”.

It is noted that, in the present description and annexed claims, the expressions “coloring a text” and “highlighting a text” (or similar ones) just imply associating a color to a text in two different manners. “Coloring a text” is used herein as an expression that means “associating a color indicative of one of the twelve degrees to a text”, while “highlighting a text” is used herein as an expression that means “associating a color indicative of a change of reference note to a text”. For instance, in the embodiments shown in the figures annexed herein, the text is “colored” by changing the color of the font (letters), and “highlighted” by drawing colored surrounding frames. In other embodiments, the text could be “colored” by resorting to highlighting of an black otherwise text, and “highlighted” by drawing colored underlines, and the like.

It is noted that, in the present description and claims, the expressions “formatting and/or annexed typesetting a text” (or similar ones) just imply associating typographical attributes to a text. “Formatting and/or typesetting a text” is used herein as an expression that means “associating specific typographical attributes to different octaves”. For instance, in the embodiments shown in the figures annexed herein, the text is “formatted/typeset” by changing the font of the text (typeface). In other embodiments, the text could be “formatted/typeset” by using different typographical attributes, individually or combined, that include, but are not limited to: weight, size, slope, width, the case of the same typeface or font, the use of different fonts of the same typeface (a font family), different baselines, typographical features like overline and/or underline, the use of diacritical marks, and the like.

As anticipated, the proposed musical notation may optionally include other symbols to represent (e.g., encode) the structure, meter and/or rhythm of the song, in combination with the color and typeface encoding previously defined that represents degrees and octaves. Advantageously, also the symbols used to represent such additional (rhythmic) information may be identified in the Unicode standard, so that a full music score of a song can be reproduced by means of conventional formatting and/or typesetting tools (e.g., a word processing software running on a computer).

For instance, concerning the structure of the song, the lyrics of a song may be typographically subdivided into several groups of lines of text according to the sections of the song. Optionally, each section may be annotated (e.g., on the left-end margin or above the section) with a corresponding name of the section, possibly using abbreviations such as CH—chorus; V—verse; BR—bridge; SP—special; TH—theme; Riff; IN —intro; OUT—outro; STR—instrumental, and the like.

In one or more embodiments, in order to avoid unnecessary repetition of information, when the melody of two sections is identical (e.g., two different verses), the lyrics of the repeated section can be typed in italic (or other distinctive font or style) without the text being colored, being assumed that the coloring of the section typed in italic should be identical to the coloring of a corresponding previous section.

Additionally, concerning the meter of the song, the initial time signature may be indicated before the beginning of the text, and may be notated “in line” with the text (e.g., using fractions ¾, 12/8 and the like instead of the corresponding time signature graphic symbols). As in the classical staff notation, the first number indicates the number of beats in each bar, and the second number (which in the proposed notation may follow a slash) indicates the type of note (i.e., the relative duration) corresponding to a single beat. Use of “in line” fractions facilitates rendering a full music score of a song by means of conventional typesetting tools. Additionally, considering the prevalence of the 4/4 meter in modern music, the time signature may be even omitted and meter 4/4 may be assumed in that case.

Additionally, concerning the rhythm of the song and in particular the section division, the lyrics may be represented in lines not following the meaning of the text and the semantic sentence organization, but representing groups of musical measures (bars) within a lyrics section in which the melody is organized. Depending on the number of the words in the lyrics, in combination with the musical meter, each line of text will usually represent a group of four, two, or one musical measures. For example, in the case of a verse having a length equal to eight measures, the lyrics may be arranged in four lines (each including a group of two measures) or two lines (each including a group of four measures).

Additionally, concerning the rhythm of the song and in particular the measure division, in one or more embodiments the text may be split in musical measures using a slash or solidus (/) or other separation mark, which may be placed before the first word of each measure. If the first pulse of a measure falls in the middle of a word, such a word can be divided by a slash placed before the first grapheme pertaining to the subsequent measure. The distance between two slashes may be constrained by the typeset text of the lyrics of the song. For instance, a single slash (/) may indicate a measure division. A double slash (//) may indicate the beginning or end of a lyric section (e.g., verse, chorus, etc.). In the presence of initial “pick up notes” before the first measure of the first song section, double square brackets ([[) may follow the notes which will be located in a line above the first section block lyric line. In the presence of text in the first and last measure of a section or lyrics line, measure slashes may be omitted, while they will be typed in the presence of a measure of full silence. For example, measures may be delimited as follows:
silent first measure of a section: //-/-
silent last measure of a section: /-//
silent measure in a lyrics line: /-/

Additionally, concerning the rhythm of the song and in particular the duration of notes and rests, it is noted that a graphic indication of the duration of notes will involve additional symbols and/or marks to be added to the text, in quantity and quality which may depend on the desired level of accuracy of the transcription. As the rhythmic complexity of a melody increases, so will its transcription, regardless of the system of notation, including the classical staff notation system. Therefore, at least two different approaches can be envisaged in various embodiments of the proposed musical notation to transcribe note and/or rest durations.

According to a first approach, text symbols and/or marks may be used to give a rough graphic/visual idea of duration of notes and rests within the musical measure in which they are contained (e.g., a hyphen or minus “−” associated to a grapheme (e.g., a syllable) can indicate a generic longer note value and a full stop “.” or a comma “,” can indicate a longer or a shorter rest, respectively).

According to a second, more accurate approach, a set of text symbols and/or marks describing with accuracy the rhythmic quality of a melody (e.g., equaling the accuracy of the staff notation system) may be employed in association with the colored relative scale system proposed herein. A series of different symbols may be interposed between graphemes for indicating the duration of rests, such as hyphen or minus “−” centered within a measure (e.g., to indicate a full measure rest regardless of time signature), full stop “.” (e.g., value depending on the type of meter: 1/4 if the meter is 4/4, 1/8 if the meter is 6/8, etc.), comma “,” (e.g., value depending on the type of meter: 1/8 if the meter is 4/4, 1/16 if the meter is 6/8, etc.), double commas “,,” (e.g., 1/16 if the meter is 4/4, etc.), triple commas “,,,”, and the like. A series of different symbols may be associated with graphemes for indicating the duration of notes and syncopation, such as hyphen or minus “-” (e.g., generally a grapheme representing the syllable or the mora-like unit also represents multiple value of the beat value if associated with one or more hyphens: one hyphen added to the grapheme means the grapheme represents a value double of the beat value, any additional hyphen increases the value by the value of one beat), circumflex accent “∧” and apostrophe “′” (e.g., a circumflex accent shows when a syllable falls a half beat ahead of the downbeat, 1/8 ahead when meter in 4/4; an apostrophe shows when a syllable falls a quarter of beat ahead of the downbeat, 1/16 ahead when meter in 4/4), as well as combining marks (e.g., diacritical marks) or underlines associated to the graphemes for indicating the beats of the melody. Other additional symbols may also be used.

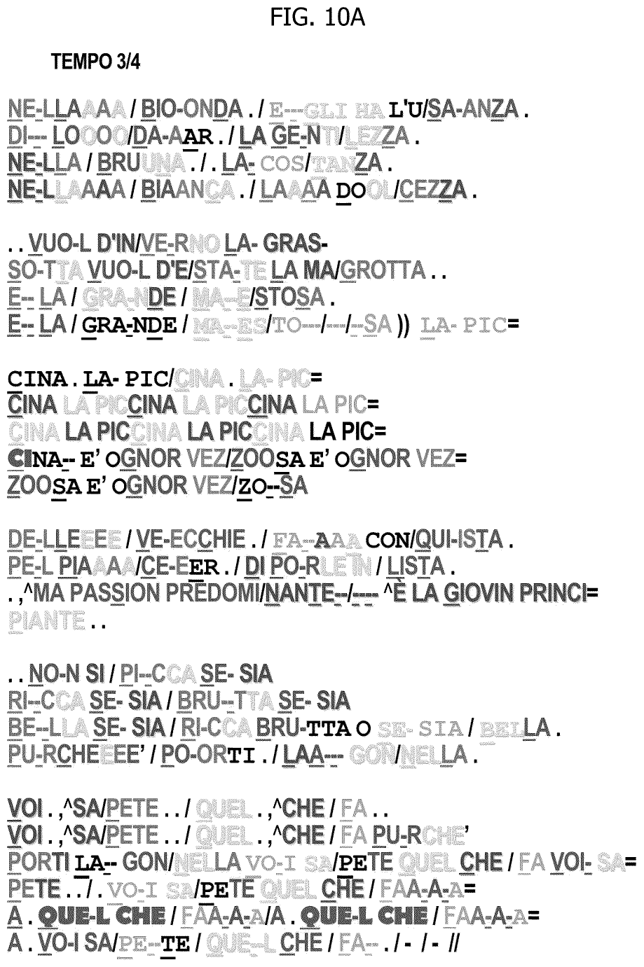

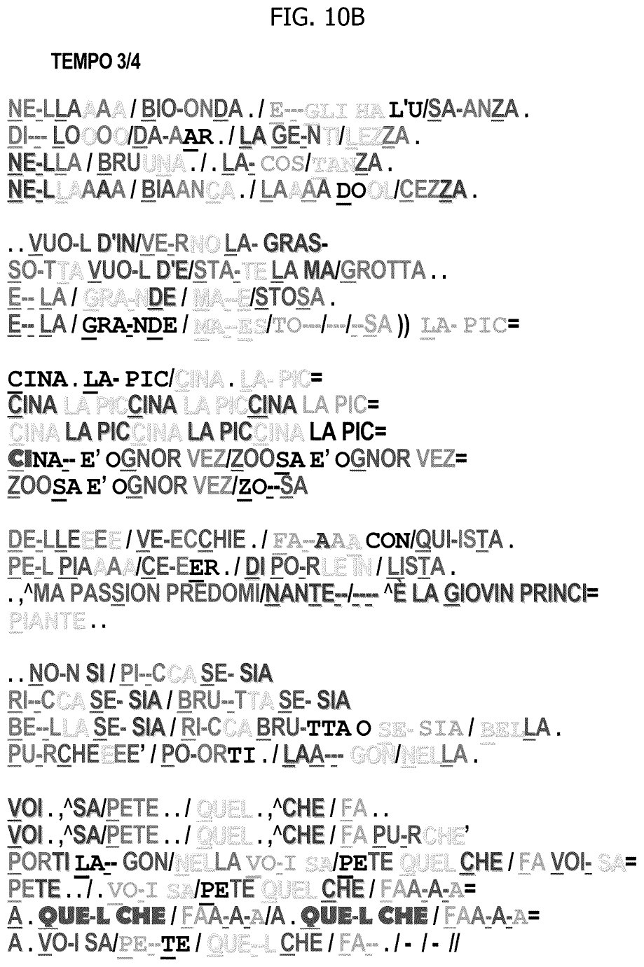

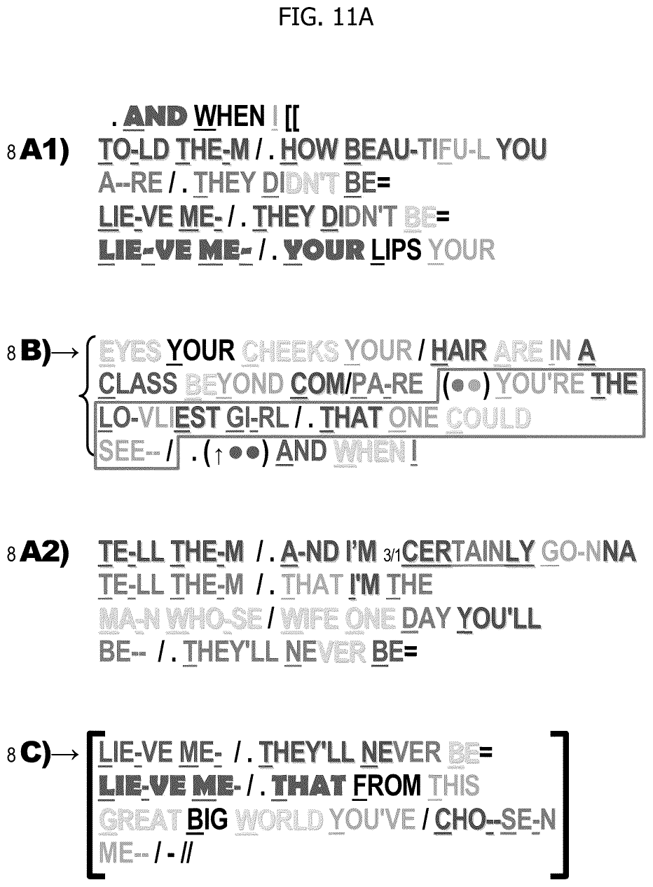

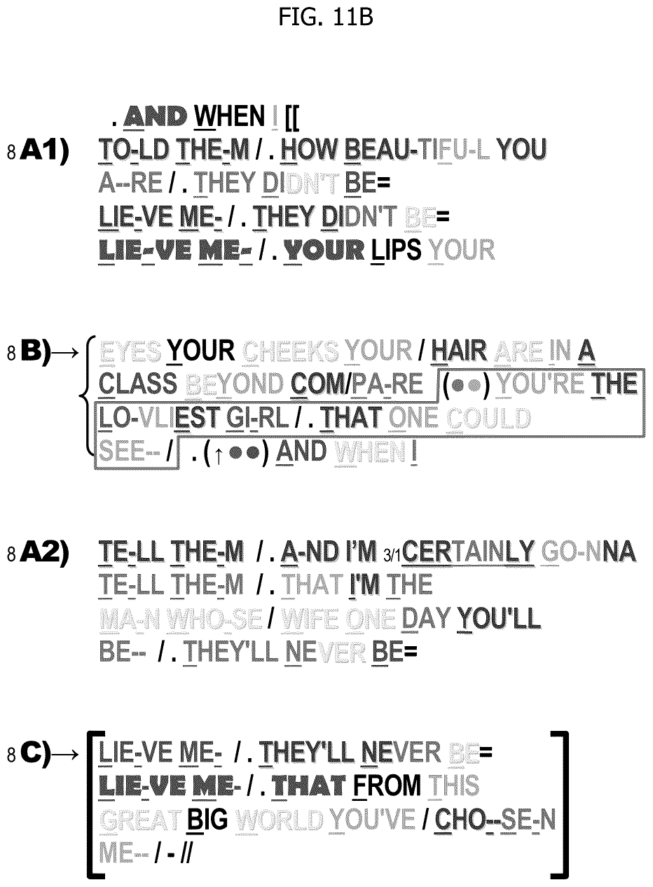

By way of example, FIG. 10A shows the full text of the aria of FIG. 8A, according to one embodiment of the musical notation proposed herein, and FIG. 10B reproduces FIG. 10A in greyscale. Similarly, FIG. 11A shows the full text of the song of FIG. 9A, according to one embodiment of the musical notation proposed herein, and FIG. 11B reproduces FIG. 11A in greyscale. In these Figures, in addition to different colors, different typefaces and colored graphic symbols, other text symbols and/or marks are used to indicate the structure, meter and/or rhythm of the song, as previously discussed. In particular, separation marks such as slashes indicate division between musical measures (bars), underscores indicate the beats within each bar, and punctuation marks indicate rests.

One or more embodiments may thus relate to a method, possibly implemented by a computer, of parsing music information and encoding the music information according to a musical notation as described herein.

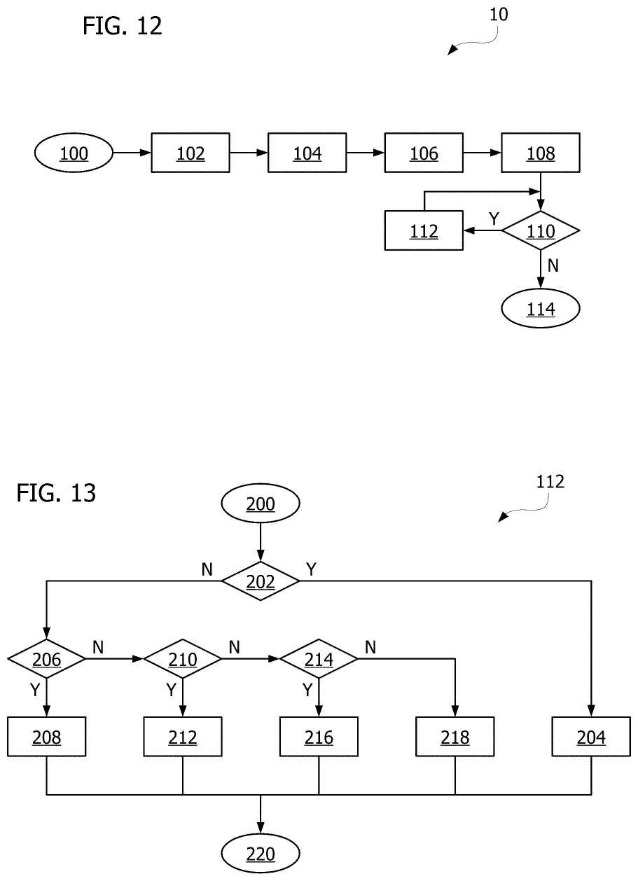

For instance, FIG. 12 is a flow diagram exemplary of a procedure 10 for analyzing music data and producing (e.g., typesetting and displaying) a song's music score encoded according to the proposed musical notation, which substantially amounts to a text (e.g., a sequence of graphemes) formatted according to specific rules. The procedure 10 starts at a start step 100. In a subsequent step 102, the procedure 10 includes identifying the meter of the song and writing it as the first portion of the output text, or optionally omitting the meter indication if the song's meter is 4/4. In a subsequent step 104, the procedure 10 includes identifying how many measures should be written in a single line of text, so as to define how long the lines of text should be. In a subsequent step 106, the procedure 10 includes identifying a reference note (e.g., the tonic) of the song's melody, or, when more reference notes are present (e.g., in the case of modulations), identifying a first reference note of the melody. In a subsequent step 108, the procedure 10 includes identifying the octave of the (first) reference note, so as to select the correct font to be used first (e.g., a medium font for the main octave, bolder fonts for lower octaves, lighter fonts for upper octaves). In a subsequent step 110, the procedure 10 includes checking whether there is a measure to be processed. In the case of a positive outcome (Y) of step 110, the procedure 10 advances to a sub-procedure 112 that includes parsing the measure's music data to output the corresponding formatted text. In the case of a negative outcome (N) of step 110, the procedure 10 terminates at a stop step 114.

FIG. 13 is a flow diagram exemplary of the sub-procedure 112 for parsing the current measure's music data and outputting the corresponding formatted text. The sub-procedure 112 starts at a start step 200. In a subsequent step 202, the sub-procedure 112 includes checking whether the current measure contains lyrics to be written. In the case of a positive outcome (Y) of step 202, the sub-procedure 112 advances to another sub-procedure 204 that includes outputting a measure containing formatted text. In the case of a negative outcome (N) of step 202, the sub-procedure 112 advances to a step 206 that includes checking whether the current measure is the first measure of the current section. In the case of a positive outcome (Y) of step 206, the sub-procedure 112 advances to step 208 that includes outputting a sequence of characters that indicates the first measure of a section (e.g., outputting “//-/” in bold). In the case of a negative outcome (N) of step 206, the sub-procedure 112 advances to a step 210 that includes checking whether the current measure is the last measure of the current section. In the case of a positive outcome (Y) of step 210, the sub-procedure 112 advances to step 212 that includes outputting a sequence of characters that indicates the last measure of a section (e.g., outputting “/-//” in bold). In the case of a negative outcome (N) of step 210, the sub-procedure 112 advances to a step 214 that includes checking whether the current measure is the last measure of a line of lyrics. In the case of a positive outcome (Y) of step 214, the sub-procedure 112 advances to step 216 that includes outputting a sequence of characters that indicates the last measure of a line of lyrics (e.g., outputting “-/” in bold). In the case of a negative outcome (N) of step 214, the sub-procedure 112 advances to step 218 that includes outputting a sequence of characters that indicates a measure in a line of lyrics (e.g., outputting “/-” in bold). After any of steps 204, 208, 212, 216 and 218 the sub-procedure 112 terminates at a stop step 220.

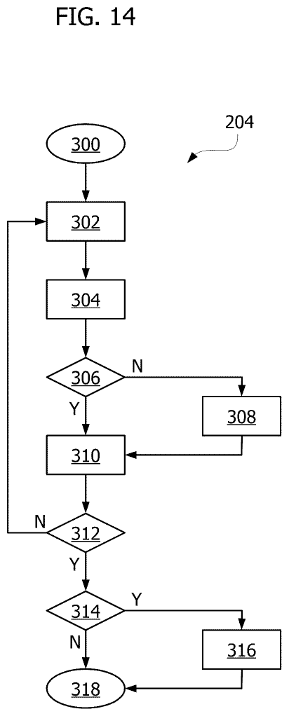

FIG. 14 is a flow diagram exemplary of the sub-procedure 204 for outputting a measure containing formatted text. The sub-procedure 204 starts at a start step 300. In a subsequent step 302, the sub-procedure 204 includes selecting the next word of the song's lyrics starting from the first word in the measure. If the word is split between the current measure and the next measure, step 302 includes selecting the part of the word belonging to the current measure and keeping the remaining part as next word. In the case of words split by a hyphen (“-”), step 302 includes taking only the part of the word up to the hyphen and keeping the remaining part as next word. Once selected the (possibly partial) word, step 302 includes identifying all notes that belong to it. In a subsequent step 304, the sub-procedure 204 includes possibly repeating the glyphs of the letters inside the selected word in order to make them match the number of notes, if the number of notes of the word does not match the number of syllables of the word. In a subsequent step 306, the sub-procedure 204 includes checking whether the first note of the selected word is on the same reference note as the previous one. In the case of a negative (N) outcome of step 306, the sub-procedure 204 advances to step 308 that includes outputting a colored sign that indicates a change of reference note. For instance, if the melody is returning to the main/first reference note, a sign that closes the part using a different reference note is output (e.g., a colored frame is closed). If instead the melody moves to a different reference note, a sign that opens the part using the new reference note is output (e.g., a colored frame of a different color); this new sign should show the degree between the new reference note and the main/first one. Optionally, all notes on this new reference note may be marked with a colored border, using the appropriate color based on the distance measured in half-steps between the two reference notes. In the case of a positive outcome (Y) of step 306, or following step 308, the sub-procedure 204 advances to step 310 that includes outputting each grapheme (syllable/vowel/letter) of the song's lyrics using the font and color that correspond to its octave and degree (intended as interval with respect to the selected reference note). For instance, a bolder font can be used for lower octaves, and a lighter font can be used for higher octaves. The color of each grapheme specifies one of the twelve degrees of the scale. In a subsequent step 312, the sub-procedure 204 includes checking whether the current measure has been completely processed. In the case of a negative outcome (N) of step 312, the procedure returns to step 302. In the case of a positive outcome (Y) of step 312, the procedure advances to step 314 that includes checking whether the current measure is the last measure of the current line of text. In the case of a positive outcome (Y) of step 314, the procedure advances to step 316 that includes outputting a new line. In the case of a negative outcome (N) of step 314, or following step 316, the sub-procedure 204 terminates at a stop step 318.

In brief, operation of a method according to one or more embodiments (the kernel) may be summarized by a first step that includes building a mapping of notes and the corresponding text (be it a single character, a syllable, a complete word or any text that should be sung while emitting that note): generally, a grapheme representing a mora-like or syllable-like unit. The same mapping may be built the other way around, i.e., starting from the text (graphemes) and looking for corresponding notes. The result should always map a single note to a portion of text corresponding to a grapheme. The second step includes looping through the map: for each note, outputting the corresponding text using a font and a color that identify the degree and the octave of that note relative to the pitch of the selected reference note. The font and color are selected according to the rules previously described.

In one or more embodiments, a method may comprise storing the encoded musical information (e.g., storing data indicative of the colored, as well as formatted and/or typeset, sequence of graphemes) in a memory of a processing unit (e.g., in a cloud server) for subsequent use. Subsequent use may comprise, for instance, printing of the sequence of graphemes on a printable sheet, and/or transmission of the stored data to a display device for visualization of the sequence of graphemes on a display screen.

In one or more embodiments, portions of instrumental only melody may also be displayed within the text of the lyrics, e.g., by using a dedicated grapheme that is interpreted by the singer as an instrumental-only note.

Without prejudice to the underlying principles, the details and embodiments may vary, even significantly, with respect to what has been described by way of example only, without departing from the extent of protection. The extent of protection is determined by the annexed claims.

TABLE I

| | | No. of | | |
|---|---|---|---|---|
| CRS | | half-steps | Exemplary pairing of the CRS | |
| Scale | | From | with the Diatonic Scale Degrees | |
| degree | | reference | Scale | |
| no. | Color | degree | degree | Degree name |
| 1 | Grey | 0 | 1 | Tonic |
| 2 | Indigo | +1 | ♭2 | Lowered supertonic |
| 3 | Cherry | +2 | 2 | Supertonic |
| 4 | Azure | +3 | ♯2 | Raised supertonic or lowered |
| | | | ♭3 | mediant |
| 5 | Green | +4 | 3 | M-Mediant |
| 6 | Yellow | +5 | 4 | Subdominant |
| 7 | Olive | +6 | ♯4 | Raised subdominant or lowered |
| | | | ♭5 | dominant |
| 8 | Red | +7 | 5 | Dominant |
| 9 | Purple | +8 | ♯5 | Raised dominant or lowered |
| | | | ♭6 | submediant |
| 10 | Black | +9 | 6 | M-submediant |
| 11 | Orange | +10 | ♯6 | Subtonic |
| | | | ♭7 | |
| 12 | Pink | +11 | 7 | Leading Tone |
| 13/1 | Grey | +12 | 8/1 | (upper) Tonic |

TABLE II

| Degree | | A natural | C | C harmonic |
|---|---|---|---|---|
| no. | | minor | major | minor |
| 1 | Grey | A | C | C |
| 2 | Indigo | | | |
| 3 | Cherry | B | D | D |
| 4 | Azure | C | | E♭ |
| 5 | Green | | E | |
| 6 | Yellow | D | F | F |
| 7 | Olive | | | |
| 8 | Red | E | G | G |
| 9 | Purple | F | | A♭ |
| 10 | Black | | A | |
| 11 | Orange | G | | |
| 12 | Pink | | B | B |
| 1 | Grey | A | C | C |

TABLE III

| Degree no. | No. of half-tones | Color (CRS) | Typeface |
|---|---|---|---|
| 9 | −4 | Purple | BERLIN SANS |
| 10 | −3 | Black | Arial Narrow |
| 11 | −2 | Orange | Arial Narrow |
| 12 | −1 | Pink | Arial Narrow |
| 1 | 0 | Grey | Arial Narrow |
| 2 | +1 | Indigo | Arial Narrow |
| 3 | +2 | Cherry | Arial Narrow |
| 4 | +3 | Azure | Arial Narrow |
| 5 | +4 | Green | Arial Narrow |
| 6 | +5 | Yellow | Arial Narrow |
| 7 | +6 | Olive | Arial Narrow |
| 8 | +7 | Red | Arial Narrow |
| 9 | +8 | Purple | Arial Narrow |
| 10 | +9 | Black | Courier |
| 11 | +10 | Orange | Courier |
| 12 | +11 | Pink | Courier |
| 1 | +12 | Grey | Courier |

1. A method of encoding music information, comprising:
accessing a database that stores music information of a song in the form of a sequence of notes and a text, the text being dividable in a sequence of graphemes, wherein each grapheme of the sequence of graphemes corresponds to a note of the sequence of notes;
selecting a reference note from said sequence of notes;
associating each note of the sequence of notes to a scale degree selected out of twelve scale degrees within an octave, relative to a reference degree that corresponds to said reference note;
associating twelve mutually different colors to the twelve scale degrees, the mutually different colors being selected as a function of a bijective scale degree-to-color function that links each scale degree to a respective color;
dividing the notes of the sequence of notes in different groups corresponding to different musical octaves, whereby each note of the sequence of notes belongs to a musical octave;
associating one or more specific typographic attributes to each of said different musical octaves; and
storing, for each of said graphemes, data indicative of the color associated to the scale degree of the note that corresponds to said grapheme and data indicative of the one or more specific typographic attributes associated to the musical octave to which the note that corresponds to said grapheme belongs.

2. The method of claim 1, comprising outputting said sequence of graphemes, wherein said outputting comprises:
coloring the text of each grapheme with the color associated to the scale degree of the note that corresponds to said grapheme;
formatting and/or typesetting the text of each grapheme with said one or more specific typographic attributes associated to the musical octave to which the note that corresponds to said grapheme belongs; and
rendering on a display support said sequence of graphemes where the text of each grapheme is colored, as well as formatted and/or typeset, wherein preferably:
said display support comprises a printable sheet and the method comprises printing said sequence of graphemes on said printable sheet, and/or
said display support comprises a display screen and the method comprises displaying said sequence of graphemes on said display screen.

3. The method of claim 1, comprising:
associating said reference note to a first scale degree out of said twelve scale degrees;
associating each other note of the sequence of notes to:
a second scale degree out of said twelve scale degrees if the other note is one ascending half-tone apart from said reference degree;
a third scale degree out of said twelve scale degrees if the other note is two ascending half-tones apart from said reference degree;
a fourth scale degree out of said twelve scale degrees if the other note is three ascending half-tones apart from said reference degree;
a fifth scale degree out of said twelve scale degrees if the other note is four ascending half-tones apart from said reference degree;
a sixth scale degree out of said twelve scale degrees if the other note is five ascending half-tones apart from said reference degree;
a seventh scale degree out of said twelve scale degrees if the other note is six ascending half-tones apart from said reference degree;
an eighth scale degree out of said twelve scale degrees if the other note is seven ascending half-tones apart from said reference degree;
a ninth scale degree out of said twelve scale degrees if the other note is eight ascending half-tones apart from said reference degree;
a tenth scale degree out of said twelve scale degrees if the other note is nine ascending half-tones apart from said reference degree;
an eleventh scale degree out of said twelve scale degrees if the other note is ten ascending half-tones apart from said reference degree; and
a twelfth scale degree out of said twelve scale degrees if the other note is eleven ascending half-tones apart from said reference degree;
associating to said first, second, third, fourth, fifth, sixth, seventh, eighth, ninth, tenth, eleventh, and twelfth scale degrees, respectively, a grey, indigo, cherry, azure, green, yellow, olive, red, purple, black, orange, and pink color.

4. The method of claim 1, comprising:
detecting a tonality of said song as a function of said music information, and
selecting the tonic note of said detected tonality as said reference note.

5. The method of claim 1, wherein said one or more specific typographic attributes associated to each of said different musical octaves comprise at least one of:
a set of different font weights;
a set of different font sizes;
a set of different font styles;
a set of different font angles;
a set of different font slopes;
a set of different font widths; and
a set of different typefaces.

6. The method of claim 1, wherein each of said different groups corresponding to different musical octaves comprises a sequence of consecutive scale degrees starting from a scale degree lying four half-tones below said reference degree and ending at a scale degree lying nine half-tones above said reference degree.

7. The method of claim 1, comprising:
dividing said sequence of notes in at least a first subsequence of notes and a second subsequence of notes;
selecting a first reference note from said first subsequence of notes and selecting a second reference note from said second subsequence of notes, the second reference note being different from the first reference note;
associating each note of the first subsequence of notes to a scale degree selected out of twelve scale degrees within an octave, relative to a reference degree that corresponds to said first reference note;
associating each note of the second subsequence of notes to a scale degree selected out of twelve scale degrees within an octave, relative to a reference degree that corresponds to said second reference note;
associating the same twelve mutually different colors to the twelve scale degrees in the first subsequence of notes and in the second subsequence of notes, the mutually different colors being selected as a function of the same bijective scale degree-to-color function that links each scale degree to a respective color; and
storing, for said second subsequence of notes, data indicative of the color corresponding to the degree of said second reference note relative to said first reference note according to said same bijective scale degree-to-color function.

8. The method of claim 7, comprising outputting said sequence of graphemes, wherein said outputting comprises highlighting the text of the graphemes of said second subsequence of notes with the color corresponding to the degree of said second reference note relative to said first reference note according to said same bijective scale degree-to-color function.

9. The method of claim 1, wherein said graphemes consist of one or more characters and/or graphic signs defined in the Unicode standard.

10. The method of claim 1, comprising:
arranging said graphemes in groups of graphemes, each group of graphemes corresponding to a different section of the song; and/or
arranging said graphemes in lines of graphemes, each line corresponding to a group of musical measures of the song, preferably four, two, or one musical measures; and/or
inserting a separation mark between graphemes belonging to different musical measures of the song; and/or
inserting one or more stuffing characters in correspondence with musical measures of the song that do not contain any grapheme; and/or
inserting beat-indicative characters and/or marks associated to the graphemes as a function of the pulse within each measure; and/or
inserting duration-indicative characters and/or marks interleaved with the graphemes as a function of the duration of the note associated to the grapheme and/or of the duration of a rest.

11. The method of claim 1, wherein the method is implemented by a computer.

12. A computer program product loadable in the memory of at least one processing device and comprising software code portions configured to cause said at least one processing device to operate according to the method of claim 1 as a result of the product being run on said at least one processing device.

13. A music information display apparatus, comprising:
a display device;
a processing device configured to operate according to the method of claim 1 to produce drive signals for said display device to render on a display support a sequence of graphemes colored with the color associated to the scale degree of the note that corresponds to said grapheme, as well as formatted and/or typeset with the one or more specific typographic attributes associated to the octave to which the note that corresponds to said grapheme belongs.

14. The music information display apparatus according to claim 13, wherein:
the display device comprises a color printer driven by the processing device to print colored ink on a sheet, or
the display device comprises a display screen driven by the processing device.
